(19) United States
(12) Patent Application Publication
(10) Pub. No.: US 2016/0098252 A1
(43) Pub. Date: Apr. 7, 2016

(54) APPLICATION DEVELOPMENT ENVIRONMENT FOR MOBILE DEVICE WITH GESTURE-BASED CODING

(71) Applicant: BlackBerry Limited, Waterloo (CA)

(72) Inventors: Lars-Johan Olof LARSBY, Eslöv (SE); Pär KJELLBERG, Gothenburg (SE); Olof STENLUND, Malmö (SE); Klas LUNDBERG, Malmö (SE); Jonas KNUTSSON, Malmö (SE); Mattias ÖHMAN, Malmö (SE); Morgan ALFREDSON, Malmö (SE); Oskar APELVI, Malmö (SE); Shailesh Kumar JAGADEESAN, Malmö (SE)

(21) Appl. No.: 14/504,973

(22) Filed: Oct. 2, 2014

(51) Int. Cl. G06F 9/44; G06F 3/0488; G06F 3/0484; G06F 9/45

(52) U.S. Cl. CPC G06F 8/33; G06F 8/41; G06F 3/0488; G06F 3/04842

(57) ABSTRACT

A software development method entails providing an application development environment on a mobile device connected to a computing device such as a desktop or laptop computer that provides a browser acting as a code editor for writing code. The code input via a keyboard of the computing device is transferred to the mobile device and compiled by the application development environment. If the code is unsuitable for local compiling, the code is transmitted to a code-compiling server. Within the application development environment, recognizable gestures may be used for fast coding. In other words, the mobile device may be programmed to recognize a gesture, to determine code corresponding to the gesture and to cause the mobile device to display the code corresponding to the gesture. For example, a swipe gesture may be used to insert a particular character not found on a hard or virtual keyboard of the mobile device.

### TECHNICAL FIELD

The present technology relates generally to software application development and, in particular, to the development of applications for mobile devices.

### BACKGROUND

When developing a software application (or “app”) for a mobile device, a developer will traditionally write, save and compile the code on a desktop or laptop computer. To test the code, the app containing the newly compiled code is either run in a mobile device simulator or downloaded, installed and run on a real mobile device. Both of these prior art techniques have their shortcomings. Downloading iterations of the app as the code evolves is cumbersome and requires assiduous management of the various versions as the app being repeatedly downloaded to the mobile device.

Simulators, on the other hand, are known to slow down the host computer. Moreover, simulators are notorious for only being able to simulate certain aspects of the mobile device. Many developers have learned by experience that simulators almost invariably fail to recreate all possible errors or bugs that may occur in real usage of the app because, in a real operating environment, the app may interact undesirably with the hardware or operating system of the mobile device or even with other apps running on the device.

A need therefore exists for an improved method and system for developing mobile device applications.

### BRIEF DESCRIPTION OF THE DRAWINGS

Further features and advantages of the present technology will become apparent from the following detailed description, taken in combination with the appended drawings, in which:

FIG. 1 is a depiction of a mobile device which may be connected to a computing device to implement the present technology;

FIG. 2 is a depiction of a system for app development;

FIG. 3 is a flowchart of a method of app development;

FIG. 4 depicts a first step in a sequence of gesture-based coding as the developer initiates a left swipe gesture;

FIG. 5 depicts a second step in the sequence of gesture-based coding as the left swipe gesture is recognized by the mobile device;

FIG. 6 depicts a third step in the sequence of gesture-based coding as the bracket character “}” is displayed and moves across the screen in response to the left swipe gesture;

FIG. 7 depicts a fourth and final step in the sequence of gesture-based coding as the bracket character “}” is placed in the correct location onscreen;

FIG. 8 depicts a diagonal gesture for invoking the slash character “/”;

FIG. 9 depicts an C-shaped gesture for invoking the term “class”; and

FIG. 10 depicts a menu listing possible attributes for an object.

It will be noted that throughout the appended drawings, like features are identified by like reference numerals.

### DETAILED DESCRIPTION

The present technology provides a novel application development environment for developing applications for mobile devices. A mobile device is connected to a computing device such as a desktop computer or laptop computer which provides a code editor in a browser environment for writing code that is transferred to an application development environment residing on the mobile device. The application development environment includes a compiler for compiling the code input via the browser on the computing device. The application development environment may assess whether the code is suitable to be locally compiled by the mobile device. If the code is too computationally intensive to compiled locally on the mobile device, the mobile device sends the code to be compiled on the cloud (e.g. on a remote server or server cluster). The built app is then sent back to the device for installation and execution. In one specific implementation, code is written by providing user input directly to the mobile device. This may be facilitated and expedited by introducing gesture-based coding whereby certain gestures (e.g. swipe left or swipe right) may be used to rapidly insert a particular character that is not normally found on the hard or virtual keyboard of the mobile device such as, for example, the brackets “{” and “}”.

Accordingly, one aspect of the present technology is a computer-implemented method that entails steps, acts or operations of providing a code editor in a browser environment on a computing device for writing code for an application and transferring the code to the mobile device connected to the computing device. The method entails determining if the mobile device is to compile the code locally in an application development environment residing on the mobile device. If the code is to be compiled locally, the method entails compiling the code in the application development environment residing on the mobile device and executing the application on the mobile device; otherwise, the method entails transmitting the code to a code-compiling server remote from the mobile device to enable the code to be compiled by the server to build the application, receiving the application from the server, installing the application on the mobile device and executing the application on the mobile device.

Another aspect of the present technology is a non-transitory computer-readable medium comprising instructions in code which when loaded into a memory and executed by a processor of a mobile device cause the mobile device to perform the above method.

Yet another aspect of the present technology is a system for software development. The system includes a computing device providing a code editor in a browser environment for writing code for an application and a mobile device connected to the computing device. The mobile device has a processor that executes an application development environment capable of compiling the code and determines if the mobile device is to compile the code locally in the application development environment. The mobile device also comprises a transceiver that cooperates with the processor for transmitting the code if the code is unsuitable for being compiled locally on the mobile device. Code unsuitable for local compiling is transmitted to a code-compiling server that is remote from the mobile device. The server has a communication port to receive the code transmitted by the mobile device. The server compiles the code to build an application, and transmits the application back to the mobile device. The mobile device, upon receiving the application from the server, is configured to install the application and to execute the application. In one implementation, the mobile device provides a web server so that the computing device connected to the mobile device can use its browser to access the coding environment on the web server.

Yet a further aspect of the present technology is a mobile device comprising a processor executing an application development environment. The mobile device includes a data connection with a computing device to receive code written using a keyboard or other user interface of the computing device. The processor is configured to assess whether it is computationally feasible to compile the code locally or whether to transmit the code to a remote server for compiling. The mobile device includes a transceiver which is instructed by the processor to transmit the code to a code-compiling server remote to enable the code to be compiled by the server to build an application and to receive the application from the server. The processor is further configured to install and execute the application on the mobile device. In one implementation, the mobile device has a user interface for receiving gestures representing code elements (predetermined fragments of code, symbols or characters, etc.) Gesture-based coding facilitates coding directly on the mobile device.

This summary is provided to highlight certain significant inventive aspects but is not intended to be an exhaustive or limiting definition of all inventive aspects of the disclosure. Other inventive aspects may be disclosed in the detailed description and drawings.

The details and particulars of these aspects of the technology will now be described below, by way of example, with reference to the drawings.

By way of overview, the present technology provides a method, system and mobile device for developing software applications for mobile devices. Code is written in a code editor in a browser environment on the developer's computing device (desktop or laptop computer) which is connected (e.g. via wired or wireless connection) to the mobile device which is hosting the application development environment. Code is thus input using a keyboard of the desktop or laptop computer and then compiled in the application development environment on the mobile device. The mobile device may be configured to determine whether the code is suitable or unsuitable for compiling locally on the mobile device, e.g. whether compiling locally is too computationally intensive for the processor of the mobile device. If it is indeed too computationally intensive for local compiling, the mobile device sends the code to a server, server cluster or cloud-computing environment for compiling. The application, once compiled and built, is returned to the developer's mobile device for installation and execution on the developer's mobile device to thereby enable testing of the application on the mobile device by the developer. This eliminates the need to use a simulator. This also reduces the complication of coding and compiling on a computer and downloading iterations of the app to the mobile device for testing. This technology may provide a number of benefits. For example, although the development environment is on the mobile device, the coding itself (text entry) is done primarily via a keyboard and browser of the connected desktop or laptop computer, thereby enabling faster and more ergonomic code entry. Additionally, in the exceptional cases where the code is inserted directly via the user interface of the mobile device (bypassing the desktop or laptop), the code editor/development environment on the mobile device supports gestures for gesture-based coding. Furthermore, most of the compiling and processing of the code is done on the mobile device and then inserted into the application that refreshes its content so that the application does not need to reinstalled or restarted, which simplifies and expedites the development cycle. Further still, in cases when the compiling and/or processing of the code cannot be done on the mobile device, the code is transmitted to a code-compiling server, cloud or server cluster so that the developer need not set up any additional environment on the developer's own computer (e.g. desktop or laptop).

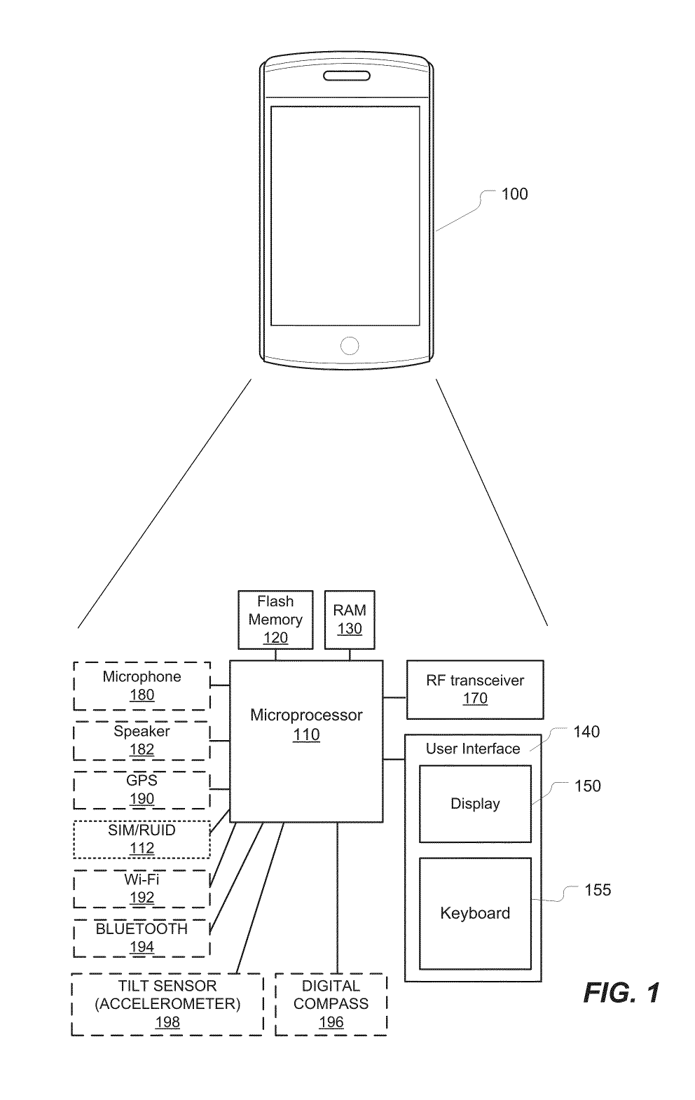

FIG. 1 is a depiction of an example mobile device which may be used to develop software applications using this novel technology. This mobile device, which is generally designated by reference numeral 100, includes a processor 110 (i.e. a microprocessor) and memory 120, 130. The processor and memory cooperate via a data bus to execute one or more applications. The memory may include flash memory 120 and/or random access memory (RAM) 130. Other types or forms of memory may be used, included or substituted. For example, the flash memory may be any other type of electronic non-volatile computer storage medium.

As depicted by way of example in FIG. 1, the mobile device 100 includes a user interface 140 for interacting with the mobile device and its applications. The user interface 140 may include one or more input/output devices, such as a display screen 150 (e.g. an LCD, LED, or OLED screen or touch-sensitive display screen), and may optionally include a keyboard or keypad. The keyboard may be a hard keyboard with physical keys or a virtual keyboard on a touch-sensitive display. The user interface may also include an optical jog pad and/or a thumbwheel, trackball, track pad or equivalent.

As depicted by way of example in FIG. 1, the mobile device 100 may include a transceiver 170 for communicating with other devices. The transceiver 170 may comprise a radiofrequency (RF) transceiver for wirelessly communicating with one or more base stations over a cellular wireless network using cellular communication protocols and standards for both voice calls and packet data transfer such as GSM, CDMA, GPRS, EDGE, UMTS, LTE, etc. Packet data may be subsequently communicated through the Internet using the TCP/IP protocol or equivalent.

Where the mobile device 100 comprises a wireless communications device, the device may include a Subscriber Identity Module (SIM) card 112 for GSM-type devices or a Re-Usable Identification Module (RUIM) card for CDMA-type devices. The RF transceiver 170 may include separate voice and data channels.

The mobile device 100 may also include one or more ports for wired connections, e.g. USB, HDMI, FireWire (IEEE 1394), etc. One of these wired connections may be used to connect the mobile device to a local computing device whose keyboard is used for text entry of the code.

The mobile device 100 optionally includes a speech-recognition subsystem that has a microphone 180 for transforming voice input in the form of sound waves into an electrical signal. The electrical signal is then processed by a speech-recognition module (digital signal processor) to determine keywords or phrases from the voice input. Optionally, the mobile device 100 may include a speaker 182 and/or an earphone jack.

The mobile device 100 optionally includes a position-determining subsystem such as a global navigation satellite system (GNSS) receiver, for example a Global Positioning System (GPS) receiver 190 (e.g. in the form of a chip or chipset) for receiving GNSS (e.g. GPS) radio signals transmitted from one or more orbiting GNSS (e.g. GPS) satellites.

Optionally, the mobile device 100 may include a Wi-Fi™ transceiver 192, a Bluetooth® transceiver 194, and/or a near-field communications (NFC) chip. The computing device 100 may also optionally include a transceiver for WiMax™ (IEEE 802.16), a transceiver for ZigBee® (IEEE 802.15.4-2003 or other wireless personal area networks), an infrared transceiver or an ultra-wideband transceiver. One of these short-range wireless connections may be used to connect the mobile device to a local computing device for typing or otherwise inputting code.

Optionally, the mobile device 100 may include other sensors like a digital compass 196 and/or a tilt sensor or accelerometer 198.

The mobile device 100 may be wireless communications device, tablet, personal digital assistant, cell phone, smart phone, smart watch, smart accessory, home appliance, kiosk, gaming device or any other electronic device that runs software.

To develop an app for the mobile device 100 in accordance with the inventive aspects of the present disclosure, the mobile device 100 is connected (by a wired or wireless connection) to another computing device (e.g. a desktop or laptop computer) 200 having a user interface that includes a keyboard or other user interface for inputting code (typing or inputting text). The computing device 200 has a memory and processor that executes a browser that provides a code editor for writing/editing code in the form of a browser environment. The code input via the computing device 200 is transferred to the memory of the mobile device 100 and compiled by a compiler within the application development environment hosted by the mobile device 100. In other words, the processor 110 of the mobile device 100 executes a development environment application on the mobile device that includes a code compiler. The user writes code using the user interface of the computing device, e.g. by typing code using a keyboard. The browser provides a code editor for writing the source code which is transferred. The code is saved in the flash memory 120 either manually (i.e. in response to a direct user command) or automatically (i.e. when the device detects that a previously programmed condition has been met). The processor is also configured to assess whether the code is suitable or unsuitable for being compiled locally on the mobile device. If a determination is made that the code is unsuitable for local compiling, e.g. because it is too computationally intensive, the code is transmitted to a remote server for compiling. To implement this, the transceiver 170 of the mobile device cooperates with (and is instructed by) the processor 110 to transmit the code to a code-compiling server remote from the mobile device to enable the code to be compiled by the server to build an application and to receive the application from the server. The processor 110 is further configured to install and execute the application on the mobile device when it is received from the server.

In one embodiment, the code may be input directly via the user interface of the mobile device. To do so, code may be input using the keyboard or keypad or it may be input using gestures. To implement the latter, the processor 110 of the mobile device is configured to recognize a gesture received by a user interface 140 of the mobile device 100, to determine code corresponding to the gesture and to cause a display 150 of the mobile device to display the code corresponding to the gesture on the mobile device.

In one embodiment, a swipe gesture corresponds to a particular character not found on a main keyboard of the mobile device 100. In one specific embodiment, a left swipe gesture corresponds to the character “}” and wherein a right swipe gesture corresponds to the character “{”.

In one embodiment, the processor 110 executes a code prediction engine to predict and display suggested code based on code written in the browser environment. For example, the engine may parse the syntax of the code written in the browser. Since the syntax represents the set of rules that defines the combinations of symbols that are considered to be a correctly structured document or fragment in that language, the engine can predict from usage or context what the next piece of code should be. Similarly, in a variant of this embodiment, the code prediction engine may list potential attributes of an object. Furthermore, if the engine recognizes that there is only one potential attribute for the object, the engine may automatically set the attribute for the object. In another variant, coding errors (e.g. syntax errors) may also be automatically corrected by the engine. These coding suggestions, attribute auto-population, and auto-correction may optionally be disabled by the developer.

In one embodiment, the mobile device 100 presents a user-selectable interface element for capturing a screenshot and for displaying a selection of options for sharing the screenshot.

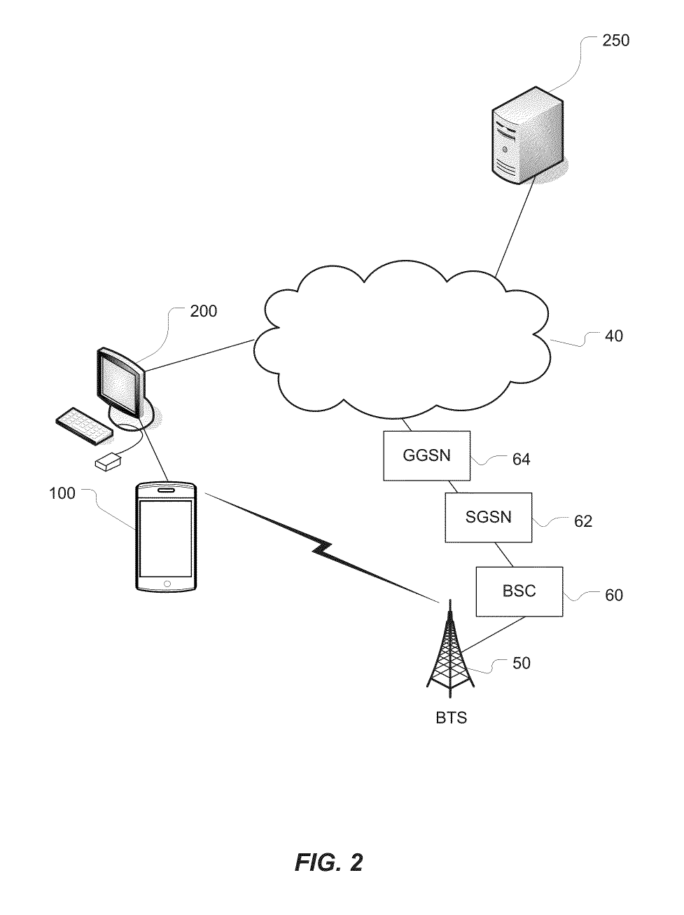

The mobile device 100 and computing device 200 cooperate to provide a novel system for software development. The system, which is depicted by way of example in FIG. 2, includes the mobile device 100 described above, i.e. a mobile device connected to the computing device 200. The computing device 200 (e.g. desktop or laptop computer) has a processor that executes a browser providing a browser environment acting as a code editor for writing code. The computing device has a keyboard and acts as a terminal to receive the user input (e.g. the typed code). The computing device 200 transfers the code unprocessed to the application development environment of the mobile device 100. The computing device 200 has a communication port for receiving a wire, cable, link, etc. to transfer data representing keystroke signals to the mobile device 100 without processing by the computing device. As such the computing device acts effectively as a data-entry terminal for the mobile device which hosts the mobile development environment. The mobile device comprises a memory for saving the code and a processor for executing the application development environment (including the compiler). The code is then compiled locally. In one implementation, the mobile device assesses or determines whether the code is suitable to be locally compiled or whether it is too computationally intensive for local compiling by the processor 110. In the latter case, if the code is considered too large to compile locally, the mobile device uses a transceiver that cooperates with the processor for transmitting the code to a server for compiling. The system thus optionally also includes a code-compiling server 250, i.e. a computer, server, server cluster, cloud service, etc. that is remote from the mobile device and its connected computing device 200. The computing device 200 does not need to be connected to the cloud as shown. All communication with the cloud may be done through the wireless connection of the mobile device. In one implementation, the mobile device 100 may communicate with the server 250 via the Internet 40 or other data network using TCP/IP or other communication protocols. Packetized data containing the code to be remotely compiled may be transmitted wirelessly from the mobile device 100 to a base transceiver station 50 which sequentially forwards the packetized data to a base station controller (BSC) 60, a serving GPRS support node (SGSN) 62, and a gateway GPRS support node (GGSN) 64. In this implementation, the server 250 compiles the code to build an application. The server 250 transmits the application back to the mobile device 100. In this system, the mobile device 100, upon receiving the application from the server, is configured to install the application and to execute the application. Installation and/or execution of the application may be user-commanded or automatic.

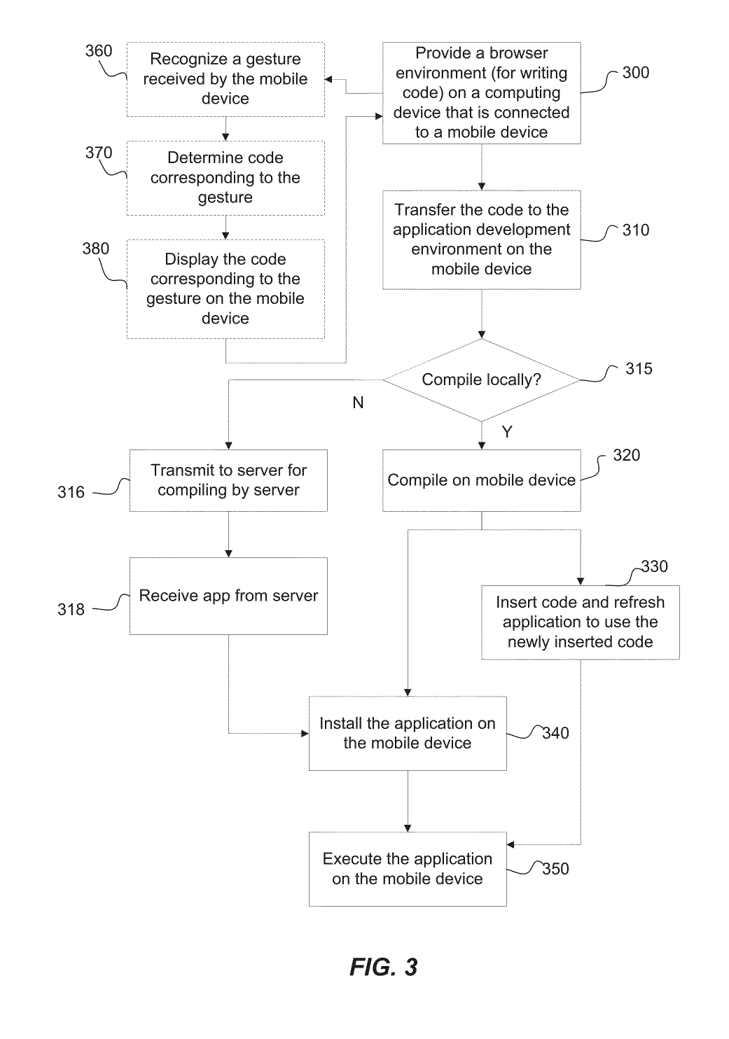

The system of the mobile device 100 connected to the local computing device 200 enables a novel computer-implemented method to be performed. This method is illustrated in flowchart in FIG. 3. The method entails providing (300) a source code editor in a browser environment of a computing device 200 for writing code which is then transferred (310) dynamically (i.e. as it is typed) to the mobile device 100 (hosting the application development environment having the compiler, debugger, etc.) and without saving the code in a non-volatile memory of the computing device 100. The code may instead be saved in a memory of the mobile device. The mobile device determines (315) whether the code is suitable to be locally compiled. If so, the mobile device compiles the code (320) although in some implementations there is no need to compile the code. In some instances, the compiled code may be inserted into the running app and the app refreshed (330). In other instances, the app with the new compiled code is installed (340) and executed (350). If the code is unsuitable for local compiling on the mobile device, the method entails transmitting (316) the code to a code-compiling server remote from the mobile device to enable the code to be compiled by the server to build an application. For code compiled off the mobile device, the method thus entails receiving (318) the application from the server, installing (340) the application on the mobile device, and executing (350) the application on the mobile device.

Writing the code in the mobile development environment may optionally entail further acts of recognizing (360) a gesture received by the mobile device, determining (370) code corresponding to the gesture, and displaying (380) the code corresponding to the gesture on the mobile device. In other words, the mobile device may be configured to receive gesture-based code commands via a user interface of the mobile device by recognizing a gesture received by the mobile device, determining code corresponding to the gesture, and causing a display of the mobile device to display the code corresponding to the gesture on the mobile device.

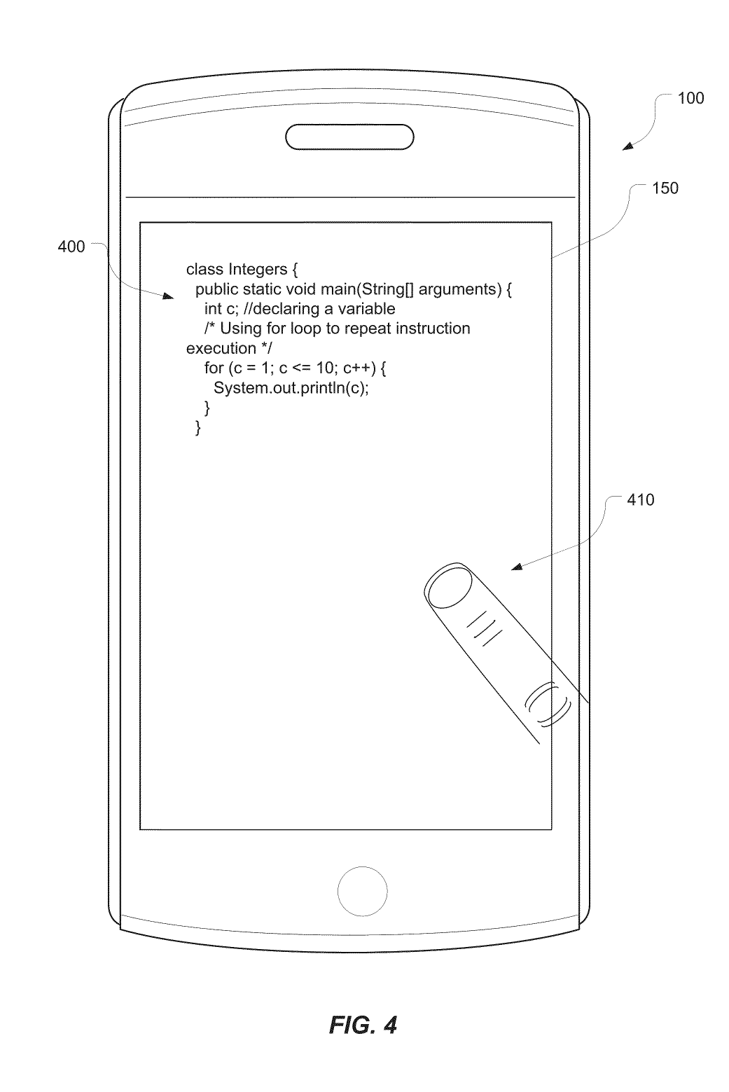

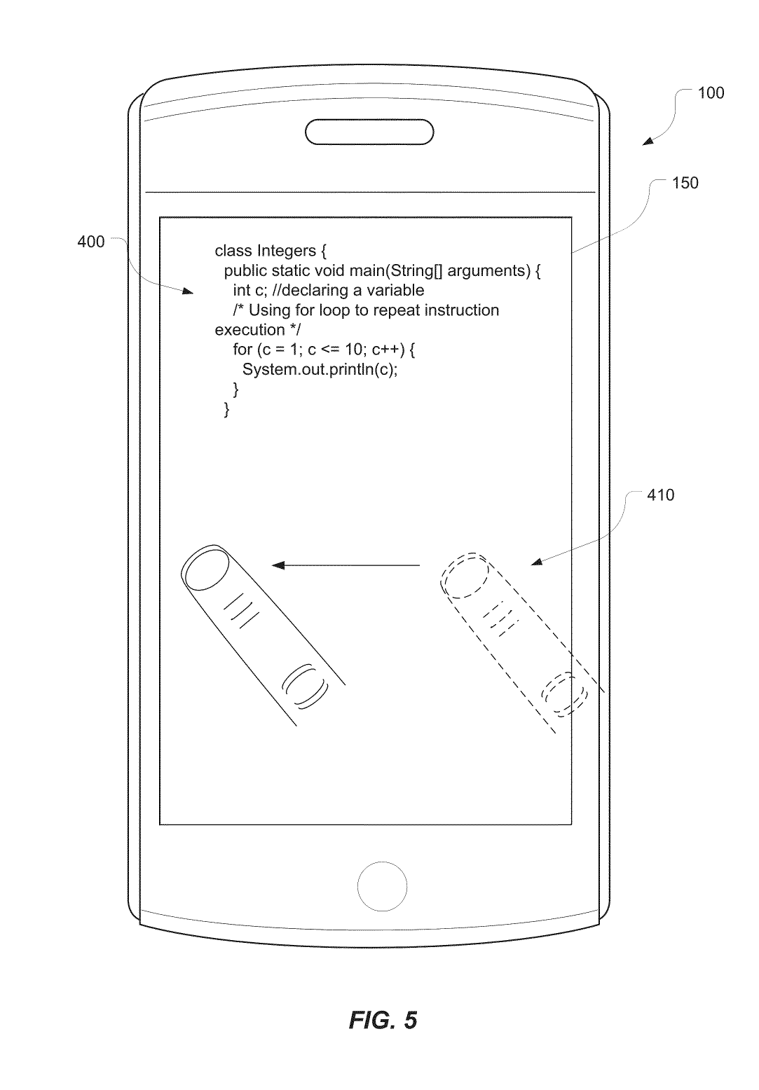

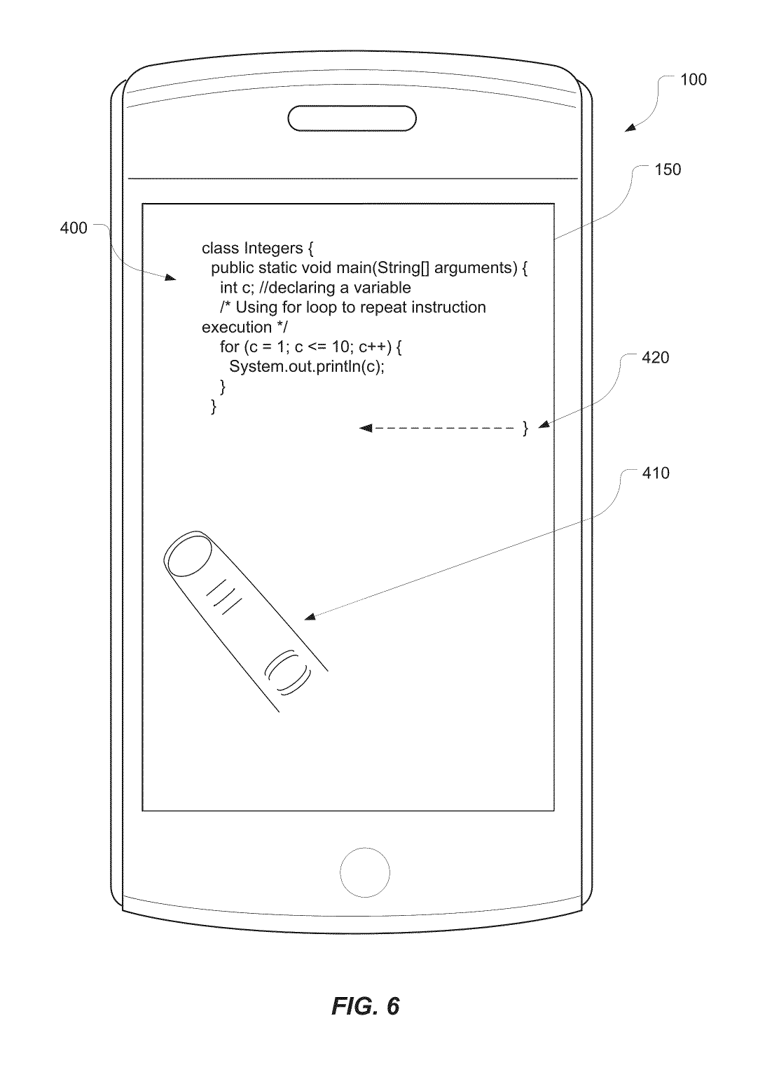

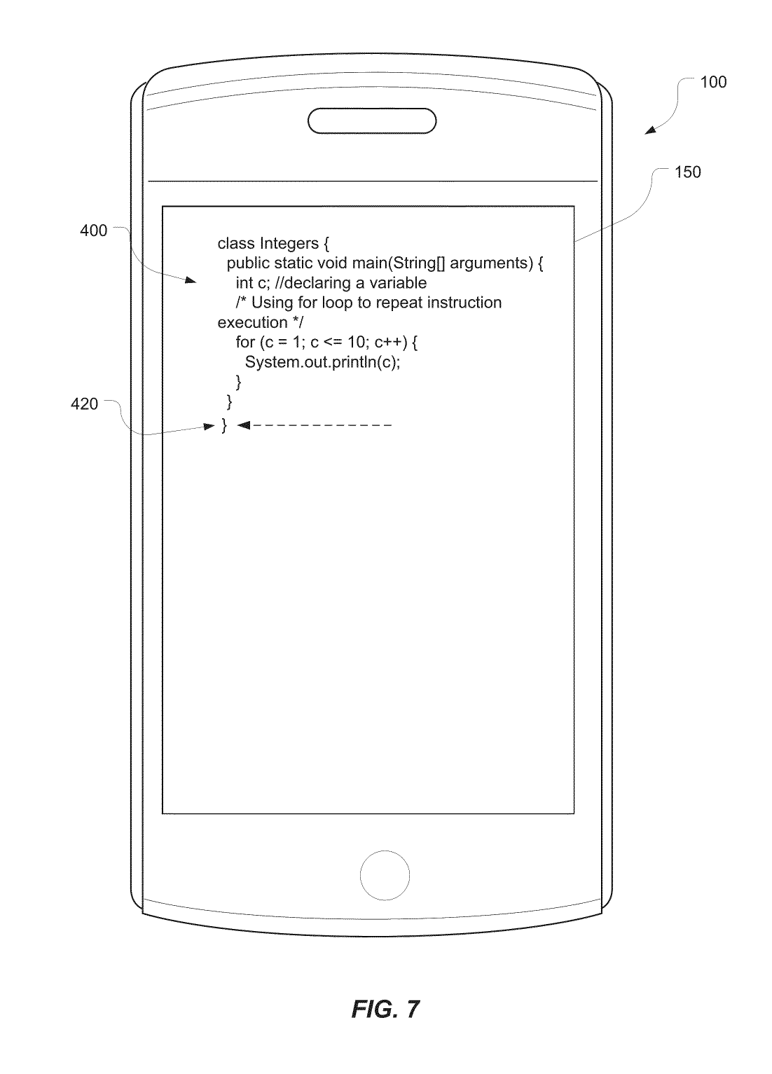

FIGS. 4-7 depict a steps in a sequence of gesture-based coding within a mobile development environment (i.e. application development environment) residing on (i.e. hosted by) a mobile device. While writing code 400 in the mobile development environment, the developer (user) may employ predefined gestures to insert code, code elements or code fragments. For example, in FIG. 4, the developer initiates a left swipe gesture. FIG. 5 depicts a second step in the sequence of gesture-based coding as the left swipe gesture 410 is recognized by the mobile device. FIG. 6 depicts a third step in the sequence of gesture-based coding as the bracket character “}” denoted by reference numeral 420 is displayed and moves across the screen in response to the left swipe gesture. The manner in which the character appears onscreen may be varied (i.e. making the character move across the screen is optional). Finally, FIG. 7 depicts a fourth and final step in the sequence of gesture-based coding as the bracket character “}” is placed in the correct location onscreen.

In the embodiment depicted in FIGS. 4-7, a swipe gesture corresponds to a predefined character not found on a main keyboard of the mobile device. In the particular illustrated embodiment, a left swipe gesture corresponds to the character “}” and a right swipe gesture corresponds to the character “{”. In FIG. 4, the left swipe gesture causes the character “}” to be inserted. The developer (user) may define a plurality of gestures to correspond to code, code elements, code fragments, etc. This is particularly useful for characters that are not available on the hard or virtual keyboard of the mobile device (and which are accessible only via an extended symbol function).

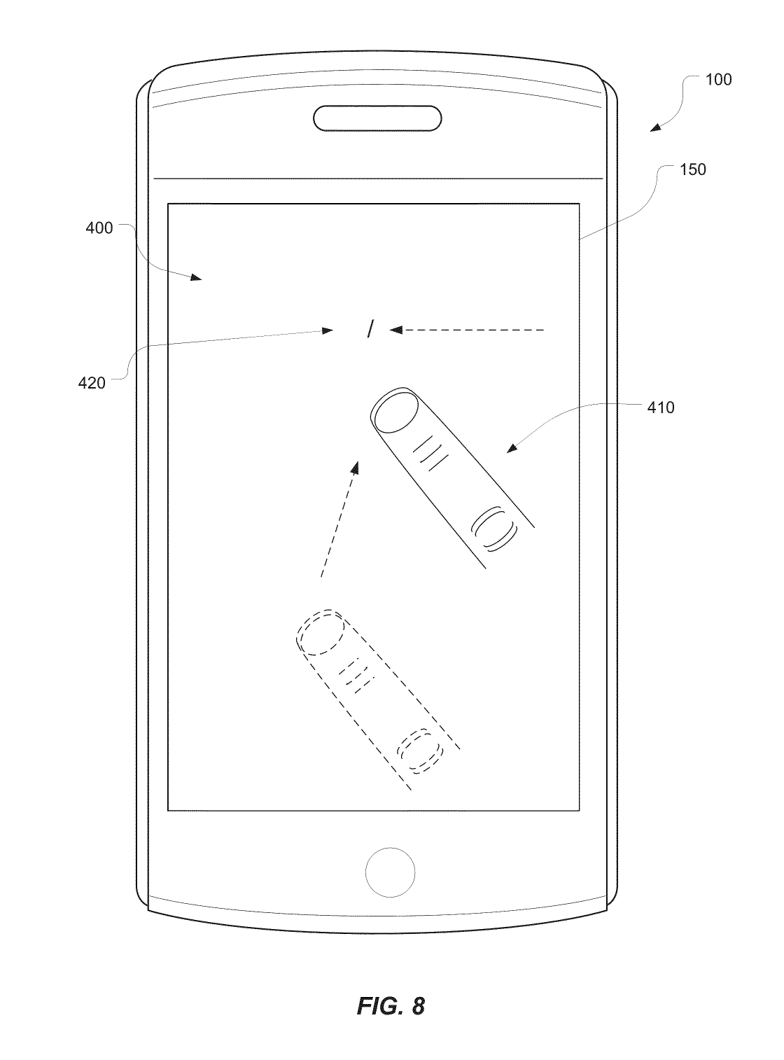

As another example of gesture-based coding, FIG. 8 depicts a diagonal gesture 410 for invoking the slash character “/” denoted by reference numeral 420.

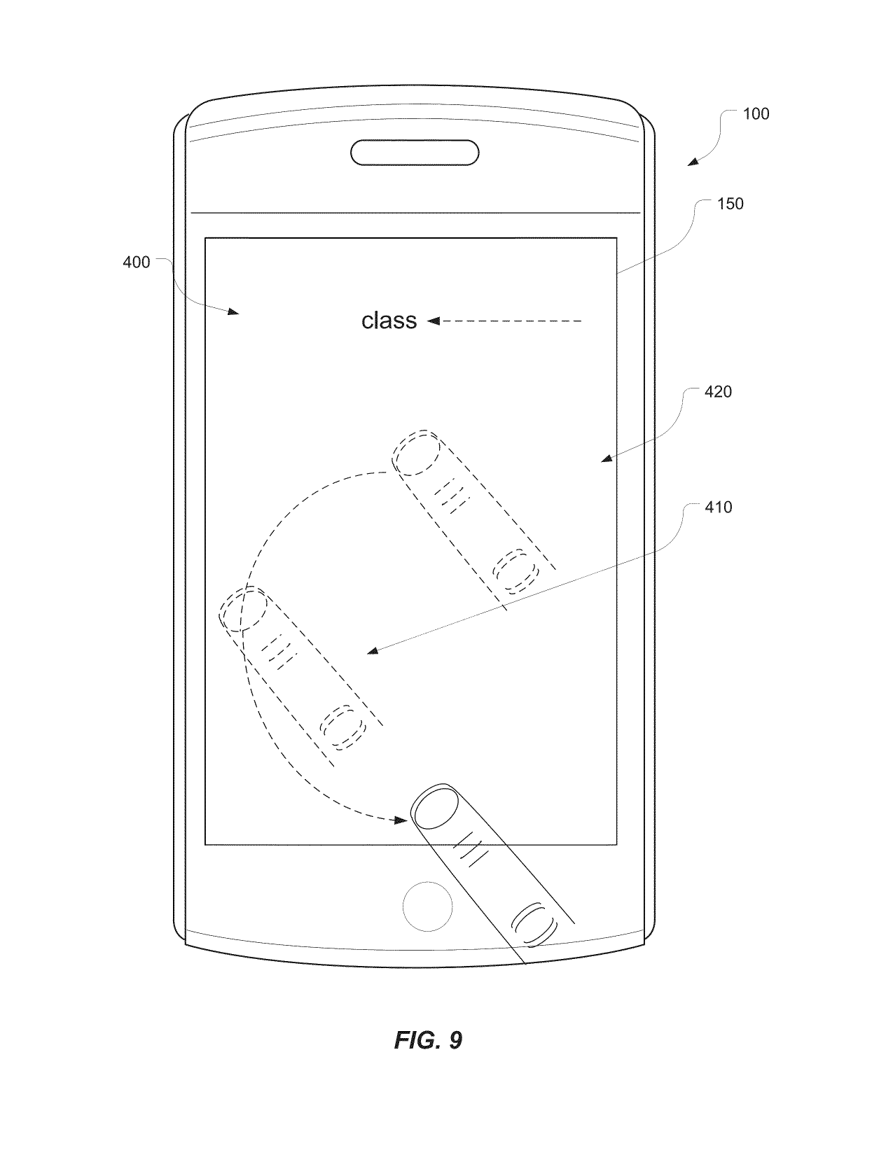

As a further example of gesture-based coding, FIG. 9 depicts an C-shaped gesture 410 for invoking the term “class” denoted by reference numeral 420.

The method may further entail executing a code prediction engine to predict and display suggested code based on code written in the browser environment.

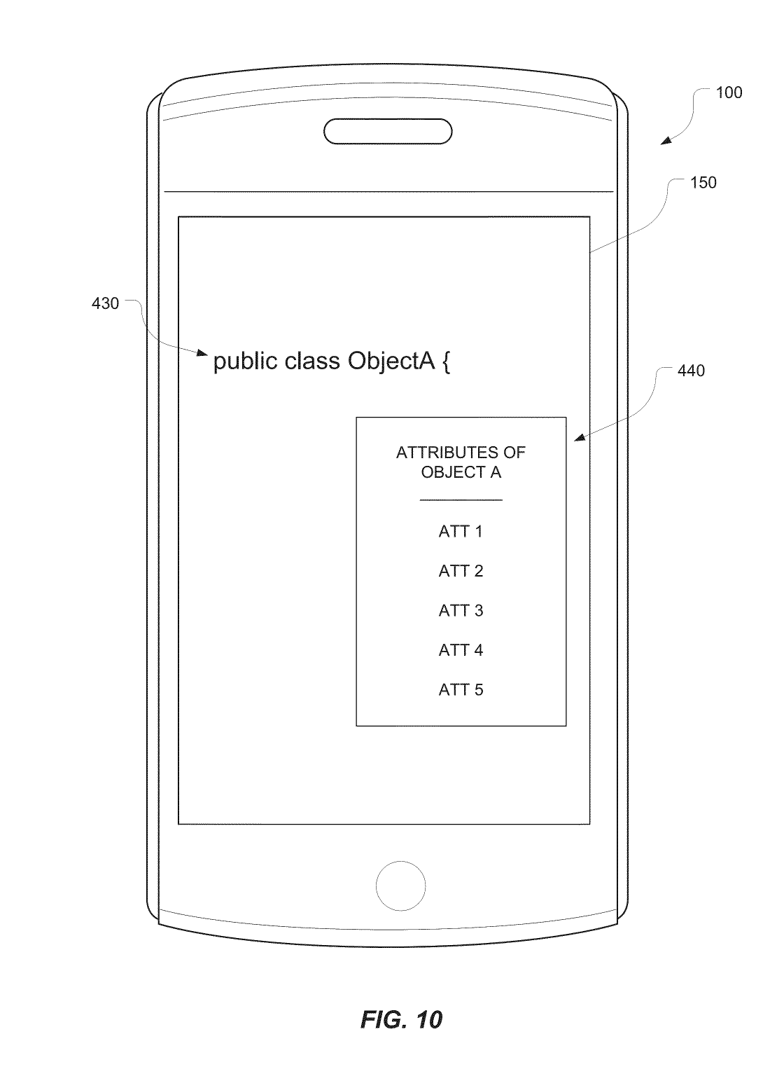

As shown by way of example in FIG. 10, the method may further entail executing a code prediction engine to list potential attributes of an object and to automatically set the attribute for the object if there is only one potential attribute for the object. As shown by way of example in FIG. 10, the engine may recognize that code 430 is being written to create or define an object. In response to this detection, the engine may cause a list or menu 440 to be displayed from which the developer may select the desired attribute(s).

Any of the methods disclosed herein may be implemented in hardware, software, firmware or any combination thereof. Where implemented as software, the method steps, acts or operations may be programmed or coded as computer-readable instructions and recorded electronically, magnetically or optically on a fixed, permanent, non-volatile or non-transitory computer-readable medium, computer-readable memory, machine-readable memory or computer program product. In other words, the computer-readable memory or computer-readable medium comprises instructions in code which when loaded into a memory and executed on a processor of a computing device cause the computing device to perform one or more of the foregoing method(s).

A computer-readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

The invention(s) has/have been described in terms of specific embodiments, implementations and configurations which are intended to be examples only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. A computer-implemented method comprising:
receiving code at a mobile device connected to a computing device that provides a code editor in a browser environment of the computing device for writing the code;
determining if the mobile device is to compile the code locally in an application development environment residing on the mobile device;
if the code is to be compiled locally, then compiling the code in the application development environment residing on the mobile device;
executing the application on the mobile device;
otherwise, transmitting the code to a code-compiling server remote from the mobile device to enable the code to be compiled by the server to build the application;
receiving the application from the server; and
executing the application on the mobile device.

2. The method as claimed in claim 1 further comprising receiving gesture-based code commands via a user interface of the mobile device by:
recognizing a gesture received by the mobile device;
determining code corresponding to the gesture; and
displaying the code corresponding to the gesture on the mobile device.

3. The method as claimed in claim 2 wherein a swipe gesture corresponds to a particular character not found on a main keyboard of the mobile device.

4. The method as claimed in claim 3 wherein a left swipe gesture corresponds to the character “}” and wherein a right swipe gesture corresponds to the character “{”.

5. The method as claimed in claim 1 further comprising executing a code prediction engine to predict and display suggested code based on code written in the browser environment.

6. The method as claimed in claim 1 further comprising executing a code prediction engine to list potential attributes of an object and to automatically set the attribute for the object if there is only one potential attribute for the object.

7. A system for software development, the system comprising:
a mobile device connected to the computing device for receiving code for an application written by a code editor in a browser environment of the computing device, the mobile device having a processor that executes an application development environment capable of compiling the code, wherein the processor determines if the mobile device is to compile the code locally in the application development environment and wherein the mobile device also comprises a transceiver that cooperates with the processor for transmitting the code if the code is unsuitable for being compiled locally on the mobile device;
a code-compiling server that is remote from the mobile device, the server having a communication port to receive the code transmitted by the mobile device, wherein the server compiles the code to build an application, and wherein the server transmits the application back to the mobile device; and
wherein the mobile device, upon receiving the application from the server, is configured to install the application and to execute the application.

8. The system as claimed in claim 7 comprising the computing device that provides a code editor in a browser environment for writing code for the application.

9. The system as claimed in claim 7 wherein the processor of the mobile device is configured to receive gesture-based code commands via a user interface of the mobile device by:
recognizing a gesture received by the mobile device;
determining code corresponding to the gesture; and
displaying the code corresponding to the gesture on the mobile device.

10. The system as claimed in claim 9 wherein a swipe gesture corresponds to a particular character not found on a main keyboard of the mobile device.

11. The system as claimed in claim 10 wherein a left swipe gesture corresponds to the character “}” and wherein a right swipe gesture corresponds to the character “{”.

12. The system as claimed in claim 8 wherein the processor executes a code prediction engine to predict and display suggested code based on code written in the browser environment.

13. The system as claimed in claim 8 wherein the processor executes a code prediction engine to list potential attributes of an object and to automatically set the attribute for the object if there is only one potential attribute for the object.

14. A non-transitory computer-readable medium comprising code which when stored in a memory and executed by a processor of a mobile device causes the mobile device to:
receive code written using a computing device connected to the mobile device, the code having being input via a code editor in a browser environment on the computing device;
determine if the mobile device is to compile the code locally in an application development environment residing on the mobile device;
if the code is to be compiled locally, then compile the code in the application development environment residing on the mobile device;
execute the application on the mobile device;
otherwise, transmit the code to a code-compiling server remote from the mobile device to enable the code to be compiled by the server to build the application;
receive the application from the server; and
execute the application on the mobile device.

15. The computer-readable medium as claimed in claim 14 wherein the code causes the mobile device to receive gesture-based code commands via a user interface of the mobile device by:
recognizing a gesture received by the mobile device;
determining code corresponding to the gesture; and
causing a display of the mobile device to display the code corresponding to the gesture on the mobile device.

16. The computer-readable medium as claimed in claim 14 wherein a swipe gesture corresponds to a particular character not found on a main keyboard of the mobile device.

17. The computer-readable medium as claimed in claim 16 wherein a left swipe gesture corresponds to the character “}” and wherein a right swipe gesture corresponds to the character “{”.

18. The computer-readable medium as claimed in claim 14 further comprising code to provide a code prediction engine to predict and display suggested code based on code written in the browser environment.

19. The computer-readable medium as claimed in claim 14 further comprising code to provide a code prediction engine to list potential attributes of an object and to automatically set the attribute for the object if there is only one potential attribute for the object.

20. The computer-readable medium as claimed in claim 14 further comprising code for displaying a user-selectable interface element for capturing a screenshot and for displaying a selection of options for sharing the screenshot.
